(19) United States
(12) Patent Application Publication
(10) Pub. No.: US 2025/0294362 A1
(43) Pub. Date: Sep. 18, 2025

(54) SECURITY ESTABLISHING METHOD AND USER EQUIPMENT

(71) Applicant: INNOPEAK TECHNOLOGY, INC., PALO ALTO, CA (US)

(72) Inventor: Marcus WONG, PALO ALTO, CA (US)

(21) Appl. No.: 18/861,449

(22) PCT Filed: Jul. 13, 2023
(86) PCT No.: PCT/US2023/027605

§ 371 Date: Oct. 29, 2024

Related U.S. Application Data
(60) Provisional application No. 63/389,163, filed on Jul. 14, 2022.

(51) Int. Cl. H04W 12/37; H04W 88/04

(52) U.S. Cl. CPC H04W 12/37; H04W 88/04

(57) ABSTRACT

A security establishing method is provided. A user equipment (UE) that serves as a UE-to-UE relay receives security-related information of a first UE and a security-related information of a second UE. The UE-to-UE relay determines a common security protection scheme for communication between the first UE and the UE-to-UE relay and communication between the second UE and the UE-to-UE relay based on the security-related information of the first UE, the security-related information of the second UE, as well as security-related information of the UE-to-UE relay. The UE-to-UE relay performs security establishment with the first UE and the second UE based on the common security protection scheme. The common security protection scheme is hop-by-hop security or end-to-end security.

### CROSS-REFERENCE TO RELATED APPLICATIONS

This application is a national phase entry under 35 USC 371 of International Patent Application No. PCT/US2023/027605 filed on Jul. 13, 2023, which claims the benefit of priority to U.S. Provisional Application No. 63/389,163, entitled “METHOD FOR SECURITY COMMUNICATION NEGOTIATION BETWEEN TWO UES VIA UE-TO-UE RELAY IN 5G,” filed on Jul. 14, 2022, which are hereby incorporated in their entirety by this reference.

### BACKGROUND OF DISCLOSURE

### 1. Field of Disclosure

The present disclosure relates to the field of communication systems, and more particularly, to a security establishing method and user equipment (UE).

### 2. Description of Related Art

Wireless communication systems, such as the third generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) that provide wireless links to the UEs located in cells covered by the base station, and an interface to a core network (CN) which provides overall network control. As will be appreciated, the RAN and CN each conduct respective functions in relation to the overall network. The 3GPP has developed the so-called Long-Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, the 3GPP has developed the so-called 5G or NR (new radio) systems where one or more cells are supported by a base station known as a gNB.

### Technical Problem

In a communication system, when two entities establish a communication link, the communication security can be end-to-end security. One example of a communication system is a secure website (HTTPS), where the user's browser (i.e., client) and the website's server communicate securely end-to-end. The link between the client and server may go through multiple hops (e.g., intermediate nodes). Any intermediate nodes in the link are not involved in the secure communication between the client and the server. This means that intermediate nodes do not provide the same security protection between the client and the server.

Another example is a wireless phone call in a wireless communication system (4G or 5G network), where Caller A calls Caller B. Caller A connects to a base station (referred to as Base Station A), then to the core network, then to another base station (referred to as Base Station B), and finally to Caller B. Security negotiation happens between Caller A and Base Station A, and between Caller B and Base Station B. Security communication is applied between each pair of nodes: Caller A and Base Station A, Base Station A and the core network, the core network and Base Station B, and Base Station B and Caller B. The security between Caller A and Caller B is called hop-by-hop security.

In 5G Proximity Services (ProSe), two User Equipments (UEs) that are out of network coverage can communicate through a UE-to-UE relay. The communication between the two UEs needs to be secured to prevent interception or modification by an attacker. The security can be either end-to-end or hop-by-hop.

The previous solutions do not consider the scenario where a UE-to-UE relay in 5G relay service connects two UEs.

### SUMMARY

An object of the present disclosure is to propose a user equipment and a security establishing method.

In a first aspect, an embodiment of the invention provides a security establishing method executable in a user equipment (UE) that serves as a UE-to-UE relay, comprising:

receiving security-related information of a first UE;

receiving security-related information of a second UE;

determining a common security protection scheme for communication between the first UE and the UE-to-UE relay and communication between the second UE and the UE-to-UE relay based on the security-related information of the first UE, the security-related information of the second UE, as well as security-related information of the UE-to-UE relay; and

performing security establishment with the first UE and the second UE based on the common security protection scheme;

wherein the common security protection scheme is hop-by-hop security or end-to-end security.

In a second aspect, an embodiment of the invention provides a user equipment (UE) comprising a processor configured to call and run a computer program stored in a memory, to cause a device in which the chip is installed to execute the disclosed method and any combination of embodiments of the disclosed method.

In a third aspect, an embodiment of the invention provides a security establishing method executable in a first user equipment (UE), comprising:

reporting a security capability and a security policy of the first UE;

performing security establishment with a UE-to-UE relay based on a common security protection scheme; and

communicating with a second UE through the UE-to-UE relay using the common security protection scheme shared by the first UE, the second UE, and the UE-to-UE relay;

wherein the common security protection scheme is hop-by-hop security or end-to-end security.

In a fourth aspect, an embodiment of the invention provides a user equipment (UE) comprising a processor configured to call and run a computer program stored in a memory, to cause a device in which the chip is installed to execute the disclosed method and any combination of embodiments of the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as a computer program product, that causes a computer to execute the disclosed method.

The disclosed method may be programmed as a computer program, that causes a computer to execute the disclosed method.

### Advantageous Effects

In 5G Proximity Services (ProSe), two user equipments (UEs) that are out of network coverage can communicate through a UE-to-UE relay. The communication between the two UEs needs security protection of end-to-end or hop-by-hop security.

UEs that support 5G relay services can use either hop-by-hop security or end-to-end security. This invention enables the UE-to-UE relay to negotiate the security mode with the first UE and the second UE. A common security protection scheme is determined and shared by the first UE, the second UE, and the UE-to-UE relay. The disclosed methods can improve incompatibilities and waste of resources in security protection for UE to UE communication, such as ProSe, vehicle to vehicle (V2V), vehicle to pedestrian (V2P), or vehicle to everything (V2X).

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field may obtain other figures according to these figures without paying the premise.

FIG. 1 illustrates a schematic view of a telecommunication system.

FIG. 2 illustrates a schematic view showing operations of a first UE in an embodiment of a security establishing method.

FIG. 3 illustrates a schematic view showing operations of a second UE in an embodiment of a security establishing method.

FIG. 4 illustrates a schematic view showing operations of a UE-to-UE relay in an embodiment of a security establishing method.

FIG. 5 illustrates a schematic view showing security establishment for UE-to-UE relay.

FIG. 6 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In the description, the following terms may be used interchangeably:
protection mechanism,
protection mode,
protection scheme,
security protection scheme,
security mode, and
security protection.

In 5G Proximity Services (ProSe), two User Equipments (UEs) that are out of network coverage can communicate through a UE-to-UE relay. The communication between the two UEs needs to be secured by a protection mechanism to prevent interception or modification by an attacker. The protection mechanism ensures the confidentiality and integrity of the data packets exchanged between the UEs via the UE-to-UE relay. The security can be either end-to-end (i.e., the data is protected for confidentiality, integrity, and replay between the two UEs) or hop-by-hop (i.e., the data is protected for confidentiality, integrity, and replay between a first UE and the UE-to-UE relay, and between the UE-to-UE relay and a second UE).

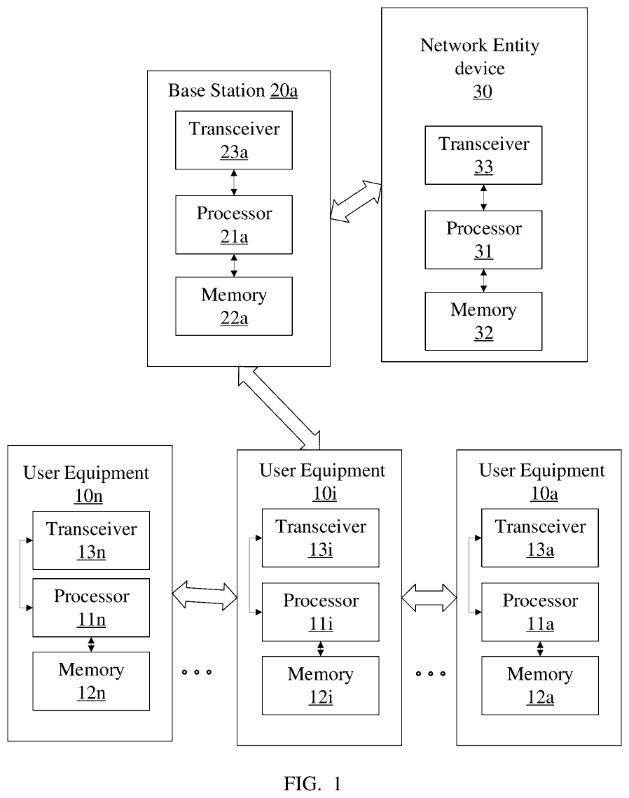

Different UEs or operators may have different security requirements depending on their security policies. Therefore, negotiation is preferred as a way to agree on the security mode for the communication. For example, the operator may set a default configuration for the UEs to always use hop-by-hop security or end-to-end security. The configuration may be sent from a base station (e.g., base station 20a in FIG. 1) to the UEs in a downlink control signal.

Different operators may have different security policies or default configurations for their UEs. For example, UEs served by a first operator (e.g., an operator A) may use hop-by-hop security by default while UEs served by a second operator (e.g., an operator B) may use end-to-end security by default. In this case, UEs from operator A and operator B will not be able to communicate securely with each other.

UEs that support 5G relay services can use either hop-by-hop security or end-to-end security. However, without a mechanism for the UEs to agree on a security method, they may fail to communicate securely. For instance, a first UE may assume hop-by-hop security with the UE-to-UE relay, while a second UE may expect end-to-end security with the first UE. Alternatively, if the first UE uses both hop-by-hop and end-to-end security, it would consume unnecessary resources of the first UE and the UE-to-UE relay without enhancing security.

Embodiments of the disclosure enable the UE-to-UE relay to negotiate the security mode with the first UE and the second UE.

A UE-to-UE relay based on the disclosure can provide secure relay service in a 5G communication system when the UEs are out of network coverage. UEs when being outside of network coverage can communicate with each other either directly using sidelink or indirectly via a relay (i.e., UE-to-UE relay). When the UEs are communicating via a UE-to-UE relay, the UE-to-UE relay based on the disclosure allows the communication between two UEs connected via the UE-to-UE relay to be secured by either end-to-end or by hop-by-hop security.

This disclosure describes a UE-to-UE relay that negotiates a protection mechanism with two UEs that want to communicate securely. When UEs are connected via a UE-to-UE relay, the UEs can report security capabilities and security policies of the UEs to the UE-to-UE relay. Based on the security capabilities and security policies of the UEs, the UE-to-UE relay then negotiates a security protection scheme that can work for both UEs. For example, a first UE belongs to a first operator and prefers to use one of end-to-end security or hop-by-hop security when communicating with a second UE, and a second UE belongs to a second operator and prefers to use one of end-to-end security or hop-by-hop security when communicating with the first UE. Upon confirming the security protection scheme, the UEs can communicate with each other securely. In some embodiments, each type of the security protection schemes may comprise one or more of the following security services: signaling integrity protection, signaling confidentiality protection, user plane integrity protection, and user plane confidentiality protection. Each of the security services may be indicated by a security policy as required, preferred, or not needed.

Since the security of communication between UEs is important, this disclosure provides a mechanism to negotiate the communication protection scheme between two UEs when the UEs are communicating with each other via a UE-to-UE relay. The mechanism ensures UEs communicating via a UE-to-UE relay can use the same security protection scheme, which may be end-to-end or hop-by-hop security.

With reference to FIG. 1, a telecommunication system including UEs 10a to 10n, a base station (BS) 20a, and a network entity device 30 executes the disclosed method according to an embodiment of the present disclosure. FIG. 1 is shown for illustrative not limiting, and the system may comprise more UEs, BSs, and CN entities. Connections between devices and device components are shown as lines and arrows in the FIGs. At least one UE 10i is in coverage of and served by the base station 20a. Two or more UEs (e.g., UE 10a and UE 10n) may in direct communication with (e.g., PC5 sidelink) the UE 10i. The variables n and i are positive integers.

The UE 10a may include a processor 11a, a memory 12a, and a transceiver 13a. The UE 10i may include a processor 11i, a memory 12i, and a transceiver 13i. The UE 10n may include a processor 11n, a memory 12n, and a transceiver 13n. The base station 20a may include a processor 21a, a memory 22a, and a transceiver 23a. The network entity device 30 may include a processor 31, a memory 32, and a transceiver 33. Each of the processors 11a, 11i, 11n, 21a, and 31 may be configured to implement proposed functions, procedures and/or methods described in the description. Layers of radio interface protocol may be implemented in the processors 11a, 11i, 11n, 21a, and 31. Each of the memory 12a, 12i, 12n, 22a, and 32 operatively stores a variety of programs and information to operate a connected processor. Each of the transceivers 13a, 13i, 13n, 23a, and 33 is operatively coupled with a connected processor, and transmits and/or receives radio signals or wireline signals. The UE 10a may be in communication with the UE 10i through a sidelink. The UE 10n may be in communication with the UE 10i through a sidelink. Similarly, any of the UEs may be in communication with the UE 10i through a sidelink. The base station 20a may be an eNB, a gNB, or one of other types of radio nodes, and may configure radio resources for the UEs.

Each of the processors 11a, 11i, 11n, 21a, and 31 may include an application-specific integrated circuit (ASICs), other chipsets, logic circuits and/or data processing devices. Each of the memory 12a, 12i, 12n, 22a, and 32 may include read-only memory (ROM), a random-access memory (RAM), a flash memory, a memory card, a storage medium and/or other storage devices. Each of the transceivers 13a, 13i, 13n, 23a, and 33 may include baseband circuitry and radio frequency (RF) circuitry to process radio frequency signals. When the embodiments are implemented in software, the techniques described herein may be implemented with modules, procedures, functions, entities, and so on, that perform the functions described herein. The modules may be stored in a memory and executed by the processors. The memory may be implemented within a processor or external to the processor, in which those may be communicatively coupled to the processor via various means are known in the art.

The network entity device 30 may be a node in a CN. CN may include LTE CN or 5G core (5GC) which includes user plane function (UPF), session management function (SMF), mobility management function (AMF), unified data management (UDM), policy control function (PCF), control plane (CP)/user plane (UP) separation (CUPS), authentication server (AUSF), network slice selection function (NSSF), and/or the network exposure function (NEF).

An example of the UE in the description may include one of the UEs 10a to 10n. An example of the base station in the description may include the base station 20a. Uplink (UL) transmission of a control signal or data may be a transmission operation from a UE to a base station. Downlink (DL) transmission of a control signal or data may be a transmission operation from a base station to a UE. A DL control signal may comprise downlink control information (DCI) or a radio resource control (RRC) signal, from a base station to a UE. Security configuration and/or policies may be carried in a DL control signal.

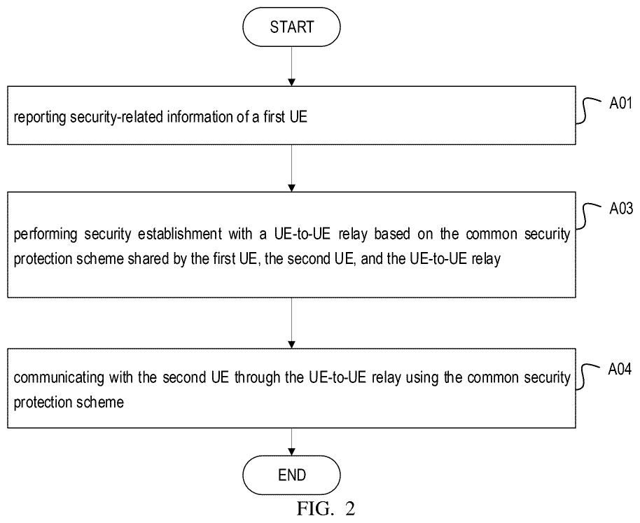

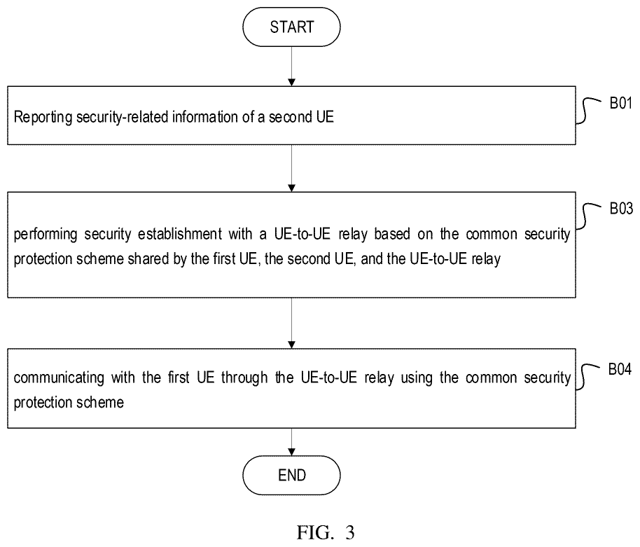

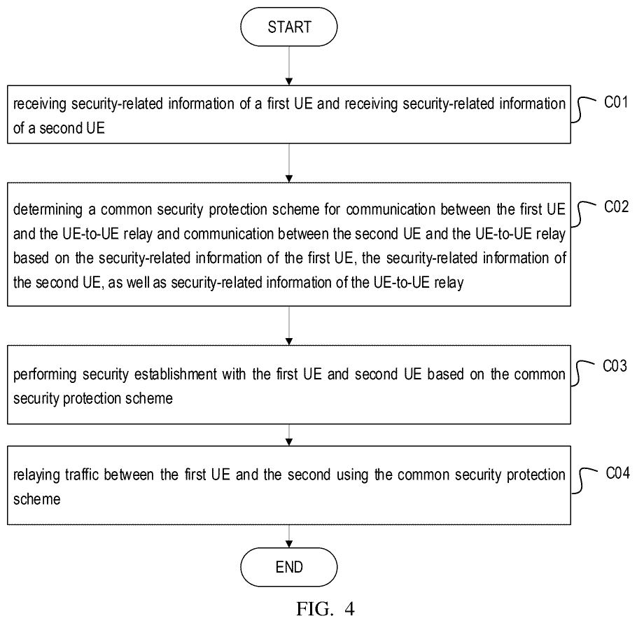

With reference to FIG. 2, FIG. 3, and FIG. 4, two UEs and a UE-to-UE relay (U2U relay) execute an embodiment of a security establishing method. The two UEs may include a first UE and a second UE. Examples of the UEs in the description may include two UEs in FIG. 1. In an example, one or both of the first UE and the second UE may be remote UEs. An example of the UE-to-UE relay in the description may include the UE 10i.

This embodiment of the disclosure addresses security requirements for the UE-to-UE relay (U2U relay) and two UEs (e.g., remote UEs) to use a common security protection scheme.

In the embodiment of the disclosure, existing provisioning, discovery, authentication, authorization, and PC5 establishment procedures in the current standards (e.g., 3GPP LTE or NR standards) may be reused for the UEs and the U2U relay. Once a source UE, a target UE, and the U2U relay have been authenticated and authorized, a common security protection scheme is applied among the source UE, target UE, and U2U relay so that the communication between source UE and target UE is protected either using hop-by-hop security protection scheme via the U2U relay or end-to-end security protection scheme between the source UE and target UE.

The first UE reports security-related information of the first UE to the UE-to-UE relay (A01). The second UE reports security-related information of the second UE to the UE-to-UE relay (B01). The UE-to-UE relay receives the security-related information of the first UE and receives the security-related information of the second UE (C01).

In an embodiment, the security-related information of the first UE may comprise a security capability of the first UE. The security-related information of the second UE may comprise a security capability of the second UE. The security-related information of the UE-to-UE relay may comprise a security capability of the UE-to-UE relay.

In an embodiment, the security-related information of the first UE may comprise a security policy of the first UE. The security-related information of the second UE may comprise a security policy of the second UE. The security-related information of the UE-to-UE relay may comprise a security policy of the UE-to-UE relay.

The security policy of the first UE, the second UE, or the UE-to-UE relay specifies a requirement or a preference of using hop-by-hop security or end-to-end security. For example, the type of security protection scheme may be indicated by a security policy as required, preferred, or not needed. The security capability of the first UE, the second UE, or the UE-to-UE relay indicates one or more of:
a capability of supporting hop-by-hop security or end-to-end security; and
a power condition.

Note that the security capability may include more types of capabilities, such as capabilities of keying, computability, and/or capabilities of the security services.

In step C02, the UE-to-UE relay determines a common security protection scheme for communication between the first UE and the UE-to-UE relay and communication between the second UE and the UE-to-UE relay based on:
the security-related information of a first UE,
the security-related information of a second UE, and
a security-related information of the UE-to-UE relay.

The common security protection scheme is hop-by-hop security or end-to-end security. In an embodiment, the communication between the first UE and the UE-to-UE relay is a PC5 sidelink, and the communication between the second UE and the UE-to-UE relay is a PC5 sidelink.

In an embodiment, security establishment of the common security protection scheme is performed during a PC5 sidelink establishment between the first UE and the UE-to-UE relay, and security establishment of the common security protection scheme is performed during a PC5 sidelink establishment between the second UE and the UE-to-UE relay.

The UE-to-UE relay performs security establishment with the first UE and the second UE based on the common security protection scheme (C03). The first UE performs security establishment with the UE-to-UE relay based on the common security protection scheme (A03). The second UE performs security establishment with the UE-to-UE relay based on the common security protection scheme (B03).

The first UE and the second UE communicate with each other through the UE-to-UE relay using the common security protection scheme shared by the first UE, the second UE, and the UE-to-UE relay (A04 and B04). The UE-to-UE relay relays traffic of the communication between the first UE and the second using the common security protection scheme shared by the first UE, the second UE, and the UE-to-UE relay (C04).

In an embodiment, the common security protection scheme is hop-by-hop security when all of the following conditions are satisfied:
the security capability and the security policy of the first UE indicate hop-by-hop security;
the security capability and the security policy of the second UE indicate hop-by-hop security; and
the security capability and the security policy of the UE-to-UE relay support hop-by-hop security.

In an embodiment, the common security protection scheme is end-to-end security when all of the following conditions are satisfied:
the security capability and the security policy of the first UE indicate end-to-end security;
the security capability and the security policy of the second UE indicate end-to-end security; and
the security capability and the security policy of the UE-to-UE relay support end-to-end security.

In an embodiment, the common security protection scheme is end-to-end security when all of the following conditions are satisfied:
the security capability and the security policy of the first UE indicate a first type of security protection scheme different from a second type of security protection scheme indicated by the security capability and the security policy of the second UE; and
the security capability and the security policy of the UE-to-UE relay support end-to-end security.

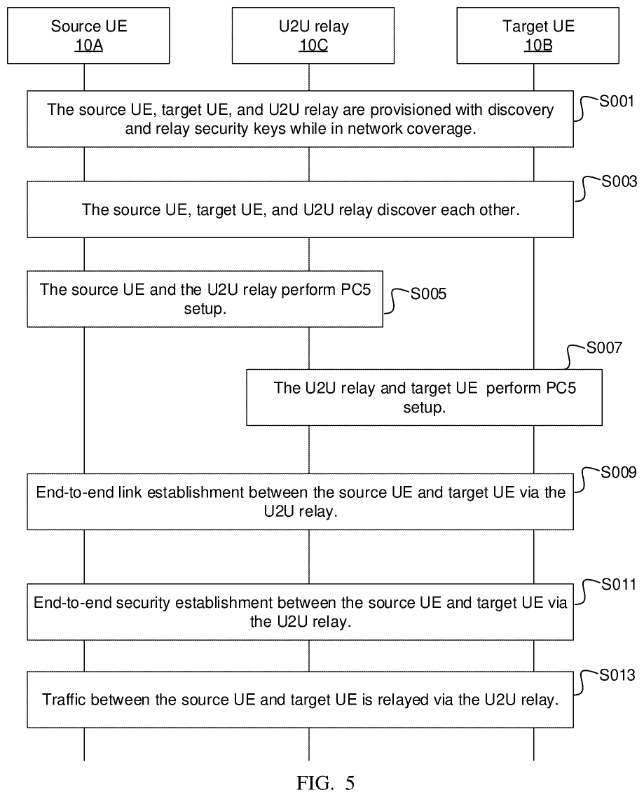

With reference to FIG. 5, an embodiment of the disclosure is provided. An example of the first UE may include a source UE 10A. An example of the second UE may include a target UE 10B. An example of the UE-to-UE relay may include a U2U relay 10C. The source UE 10A, target UE 10B, and U2U relay 10C may be UEs shown in FIG. 1, such as Ues 10a, 10n, and 10i.

S001: When still in network coverage, the source UE 10A, target UE 10B, and the U2U relay 10C get the discovery parameters. The source UE and target UE 10B can be provisioned with the security materials for PC5 security setup or end-to-end security setup. The discovery parameters and security materials may be provided by the base station 20a in downlink control signals. Additionally, the source UE 10A, target UE 10B and U2U relay 10C can be provisioned with a security policy for the security protection scheme to be used for communication between source UE 10A and target UE 10B.

S003: The source UE 10A, U2U relay 10C, and target UE 10B discover each other.

S005: During a PC5 link setup procedure between the source UE 10A and U2U relay 10C, based on the security policy of either the source UE 10A or U2U relay 10C, the PC5 link setup procedure may include security establishment between the source UE 10A and U2U relay 10C. The PC5 link establishment procedure may need to be enhanced to indicate which type of security is to be applied.

For example, if the security policy (e.g., a flag or indicator) of the source UE 10A is to use hop-by-hop security protection, the source UE 10A indicates the security policy to the U2U relay 10C by a Direct Communication Request followed by a Direct Auth and key Establishment procedure. The Direct Communication Request is a request message used in direct communication. The Direct Auth and key Establishment procedure is a direct communication authentication and key establishment procedure. Details of the Direct Communication Request and the Direct Auth and key Establishment procedure are specified in TS 33.536 and other related 3GPP technical specifications (TSs).

If the security policy of the U2U relay 10C is the same as the source UE 10A, the U2U relay 10C continues with and completes the PC5 link setup procedure, including the Direct Security Mode procedure. Completion of the Direct Security Mode procedure is signaled by a message of Direct Security Mode Complete. The Direct Security Mode procedure and the message of Direct Security Mode Complete are specified in TS 33.536 and other related 3GPP technical specifications (TSs). This means that the PC5 link setup includes security establishment that realizes hop-by-hop security between the source UE 10A and the U2U relay 10C. Otherwise, the source UE 10A and U2U relay 10C only set up the PC5 without security protection. After both source UE 10A and U2U relay 10C are aware of the security protection to be used (e.g., hop-by-hop), the U2U relay 10C performs a PC5 link setup procedure with target UE 10B.

In some cases, the U2U relay 10C may have limited resources, such as low power, that prevent it from providing hop-by-hop security If the U2U relay 10C cannot support hop-by-hop security due to capacity constraints, the U2U relay 10C can change (i.e., overwrite) the security policy of the source UE 10A to a different policy that only requires end-to-end security protection.

In another example, if the security policy (e.g., a flag or indicator) of the source UE 10A is to use end-to-end security protection, the source UE 10A indicates the security policy to the U2U relay 10C by a Direct Communication Request followed by a Direct Auth and key Establishment procedure.

If the security policy of the U2U relay 10C is the same as the source UE 10A, the U2U relay 10C continues with and completes the PC5 link setup procedure, including the Direct Security Mode procedure. Completion of the Direct Security Mode procedure is signaled by a message of Direct Security Mode Complete. This means that the PC5 link setup does not include security establishment that realizes hop-by-hop security between the source UE 10A and the U2U relay 10C. The source UE 10A and U2U relay 10C only set up the PC5 without hop-by-hop security protection. After both source UE 10A and U2U relay 10C are aware of the security protection to be used (e.g., end-to-end), the U2U relay 10C performs a PC5 link setup procedure with target UE 10B.

S007: During a PC5 link setup procedure between the U2U relay 10C and target UE 10B, the U2U relay 10C has been aware of the security protection scheme to be used between source UE 10A and U2U relay 10C. The U2U relay 10C proceeds to set up a PC5 link with the target UE 10B with the same security protection scheme as the one between the source UE 10A and U2U relay 10C. If hop-by-hop security protection has been established between source UE 10A and U2U relay 10C, the PC5 link setup includes security establishment between the target UE 10B and U2U relay 10C. If the security policy of the target UE 10B is to use end-to-end security, target UE 10B may reject the PC5 link setup by including an appropriate reason for rejecting the setup. Otherwise, target UE 10B and U2U relay 10C complete the PC5 link setup procedure including security establishment. The security establishment realizes hop-by-hop security between the target UE 10B and the U2U relay 10C.

S009: If a security link (a link of end-to-end security or hop-by-hop security) has been established between source UE 10A and target UE 10B via U2U relay 10C during the PC5 link setup procedure, the U2U relay 10C determines that PC5 security between the source UE 10A, target UE 10B, and the U2U relay 10C has been activated, and that end-to-end security is not needed. Step S011 is skipped.

S011: When Steps S005 and S007 do not contain security establishment during PC5 link setup, the source UE 10A, target UE 10B, and U2U relay 10C determine that PC5 security has not been activated and that end-to-end security is needed. The source UE 10A and target UE 10B perform end-to-end security establishment between source UE 10A and target UE 10B.

S013: Traffic between source UE 10A and target UE 10B continues. Depending on the previous steps taken, the traffic between source UE 10A and target UE 10B is either protected hop-by-hop or end-to-end.

UEs that support 5G relay services can serve as the UE-to-UE relay and use either hop-by-hop security or end-to-end security. This invention enables the UE-to-UE relay to negotiate the security mode with the first UE and the second UE. A common security protection scheme is determined and shared by the first UE, the second UE, and the UE-to-UE relay. The disclosed methods can improve incompatibilities and waste of resources in security protection for UE to UE communication, such as ProSe, vehicle to vehicle (V2V), vehicle to pedestrian (V2P), or vehicle to everything (V2X).

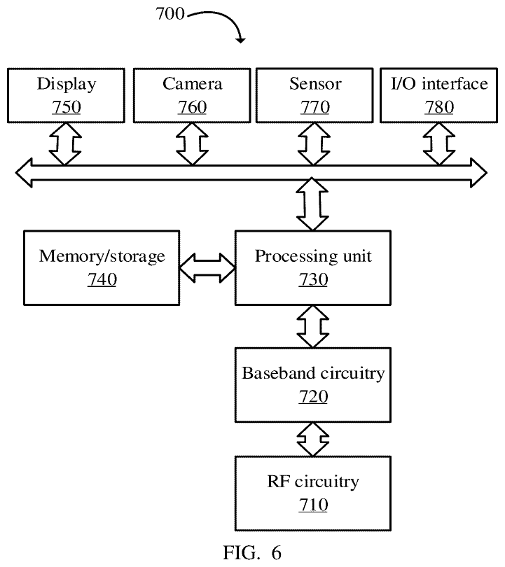

FIG. 6 is a block diagram of an example system 700 for wireless communication according to an embodiment of the present disclosure. Embodiments described herein may be implemented into the system using any suitably configured hardware and/or software. FIG. 6 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, or gNB may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for the system. The memory/storage for one embodiment may include any combination of suitable volatile memory, such as dynamic random-access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply Interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that may be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of the application and design requirement for a technical plan. A person having ordinary skill in the art may use different ways to realize the function for each specific application while such realizations should not go beyond the scope of the present disclosure. It is understood by a person having ordinary skill in the art that he/she may refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure may be realized in other ways. The above-mentioned embodiments are exemplary only. The division of the units is merely based on logical functions while other divisions exist in realization. It is possible that a plurality of units or components are combined or integrated into another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments may be integrated into one processing unit, physically independent, or integrated into one processing unit with two or more than two units.

If the software function unit is realized and used and sold as a product, it may be stored in a readable storage medium in a computer. Based on this understanding, the technical plan proposed by the present disclosure may be essentially or partially realized as the form of a software product. Or, one part of the technical plan beneficial to the conventional technology may be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random-access memory (RAM), a floppy disk, or other kinds of media capable of storing program codes.

In 5G Proximity Services (ProSe), two User Equipments (uEs) that are out of network coverage can communicate through a UE-to-UE relay. The communication between the two uEs needs security protection of end-to-end or hop-by-hop security. uEs that support 5G relay services can use either hop-by-hop security or end-to-end security. This invention enables the UE-to-UE relay to negotiate the security mode with the first UE and the second UE. A common security protection scheme is determined and shared by the first UE, the second UE, and the UE-to-UE relay. The disclosed methods can improve incompatibilities and waste of resources in security protection for UE to UE communication, such as ProSe, vehicle to vehicle (V2V), vehicle to pedestrian (V2P), or vehicle to everything (V2X).

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A security establishing method for execution by a user equipment (UE) that serves as a UE-to-UE relay, comprising:
receiving security-related information of a first UE;
receiving security-related information of a second UE;
determining a common security protection scheme for communication between the first UE and the UE-to-UE relay and communication between the second UE and the UE-to-UE relay based on the security-related information of the first UE, the security-related information of the second UE, as well as security-related information of the UE-to-UE relay; and
performing security establishment with the first UE and the second UE based on the common security protection scheme;
wherein the common security protection scheme is hop-by-hop security or end-to-end security.

2. The security establishing method of claim 1, wherein the security-related information of the first UE comprises a security capability of the first UE;
the security-related information of the second UE comprises a security capability of the second UE; and
the security-related information of the UE-to-UE relay comprises a security capability of the UE-to-UE relay.

3. The security establishing method of claim 1, wherein the security-related information of the first UE comprises a security policy of the first UE;
the security-related information of the second UE comprises a security policy of the second UE; and
the security-related information of the UE-to-UE relay comprises a security policy of the UE-to-UE relay.

4. The security establishing method of claim 1, further comprising:
relaying traffic between the first UE and the second using the common security protection scheme.

5. The security establishing method of claim 1, wherein the communication between the first UE and the UE-to-UE relay is a PC5 sidelink, and the communication between the second UE and the UE-to-UE relay is a PC5 sidelink.

6. The security establishing method of claim 1, wherein security establishment of the common security protection scheme is performed during a PC5 sidelink establishment between the first UE and the UE-to-UE relay; and
security establishment of the common security protection scheme is performed during a PC5 sidelink establishment between the second UE and the UE-to-UE relay.

7. The security establishing method of claim 2, wherein the security capability of the first UE, the second UE, or the UE-to-UE relay indicates one or more of:
a capability of supporting hop-by-hop security or end-to-end security; and
a power condition.

8. The security establishing method of claim 3, wherein the security policy of the first UE, the second UE, or the UE-to-UE relay specifies a requirement or a preference of using hop-by-hop security or end-to-end security.

9. The security establishing method of claim 1, wherein the common security protection scheme is hop-by-hop security when all of the following conditions are satisfied:
the security capability and the security policy of the first UE indicate hop-by-hop security;
the security capability and the security policy of the second UE indicate hop-by-hop security; and
the security capability and the security policy of the UE-to-UE relay support hop-by-hop security.

10. The security establishing method of claim 1, wherein the common security protection scheme is end-to-end security when all of the following conditions are satisfied:
the security capability and the security policy of the first UE indicate end-to-end security;
the security capability and the security policy of the second UE indicate end-to-end security; and
the security capability and the security policy of the UE-to-UE relay support end-to-end security; or
the common security protection scheme is end-to-end security when all of the following conditions are satisfied:
the security capability and the security policy of the first UE indicate a first type of security protection scheme different from a second type of security protection scheme indicated by the security capability and the security policy of the second UE; and
the security capability and the security policy of the UE-to-UE relay support end-to-end security.

11. (canceled)

12. A user equipment (UE), serving as a UE-to-UE relay and comprising:
a processor configured to call and run a computer program stored in a memory, to cause a device in which the processor is installed to execute:
receiving security-related information of a first UE;
receiving security-related information of a second UE;
determining a common security protection scheme for communication between the first UE and the UE-to-UE relay and communication between the second UE and the UE-to-UE relay based on the security-related information of the first UE, the security-related information of the second UE, as well as security-related information of the UE-to-UE relay; and
performing security establishment with the first UE and the second UE based on the common security protection scheme;
wherein the common security protection scheme is hop-by-hop security or end-to-end security.

13-16. (canceled)

17. A security establishing method for execution by a first user equipment (UE), comprising:
reporting security-related information of the first UE, wherein the security-related information comprises a security capability and/or a security policy of the first UE;
performing security establishment with a UE-to-UE relay based on a common security protection scheme; and
communicating with a second UE through the UE-to-UE relay using the common security protection scheme shared by the first UE, the second UE, and the UE-to-UE relay;
wherein the common security protection scheme is hop-by-hop security or end-to-end security.

18. The security establishing method of claim 17, wherein the UE-to-UE relay relays traffic between the first UE and the second using the common security protection scheme.

19. The security establishing method of claim 17, wherein the communication between the first UE and the UE-to-UE relay is a PC5 sidelink, and the communication between the second UE and the UE-to-UE relay is a PC5 sidelink.

20. The security establishing method of claim 17, wherein security establishment of the common security protection scheme is performed during a PC5 sidelink establishment between the first UE and the UE-to-UE relay; and
security establishment of the common security protection scheme is performed during a PC5 sidelink establishment between the second UE and the UE-to-UE relay.

21. The security establishing method of claim 17, wherein the security capability of the first UE indicates one or more of:
a capability of supporting hop-by-hop security or end-to-end security; and
a power condition.

22. The security establishing method of claim 17, wherein the security policy of the first UE specifies a requirement or a preference of using hop-by-hop security or end-to-end security.

23. The security establishing method of claim 17, wherein the common security protection scheme is hop-by-hop security when all of the following conditions are satisfied:
the security capability and the security policy of the first UE indicate hop-by-hop security;
the security capability and the security policy of the second UE indicate hop-by-hop security; and
the security capability and the security policy of the UE-to-UE relay support hop-by-hop security.

24. The security establishing method of claim 17, wherein the common security protection scheme is end-to-end security when all of the following conditions are satisfied:
the security capability and the security policy of the first UE indicate end-to-end security;
the security capability and the security policy of the second UE indicate end-to-end security; and
the security capability and the security policy of the UE-to-UE relay support end-to-end security; or
the common security protection scheme is end-to-end security when all of the following conditions are satisfied:
the security capability and the security policy of the first UE indicate a first type of security protection scheme different from a second type of security protection scheme indicated by the security capability and the security policy of the second UE; and
the security capability and the security policy of the UE-to-UE relay support end-to-end security.

25-30. (canceled)

31. The UE of claim 12, wherein the security-related information of the first UE comprises a security capability of the first UE;
the security-related information of the second UE comprises a security capability of the second UE; and
the security-related information of the UE-to-UE relay comprises a security capability of the UE-to-UE relay; or
the security-related information of the first UE comprises a security policy of the first UE;
the security-related information of the second UE comprises a security policy of the second UE; and
the security-related information of the UE-to-UE relay comprises a security policy of the UE-to-UE relay.
